(19) United States
(12) Patent Application Publication
(10) Pub. No.: US 2006/0185556 A1
(43) Pub. Date: Aug. 24, 2006

(54) Mixture of fiber reactive dye compounds and dyeing method using the same

(76) Inventors: Sung Yong Cho, Seoul (KR); Ju Seog Kang, Goyang-si (KR); Seok Jin Kim, Yongin-si (KR); Woo Jin Yoon, Seoul (KR)

Correspondence Address: CANTOR COLBURN, LLP, 55 GRIFFIN ROAD SOUTH, BLOOMFIELD, CT, 06002, US

(21) Appl. No.: 11/338,983

(22) Filed: Jan. 25, 2006

(30) Foreign Application Priority Data
Jan. 25, 2005 (KR) 10-2005-0006616

(51) Int. Cl. C08L 1/24

(52) U.S. Cl. 106/166.41

(57) ABSTRACT

Provided is a fiber-reactive dye mixture, comprising (i) one or more reactive dyes represented by Formula 1, and
(ii) one or more reactive dyes represented by Formula 2: 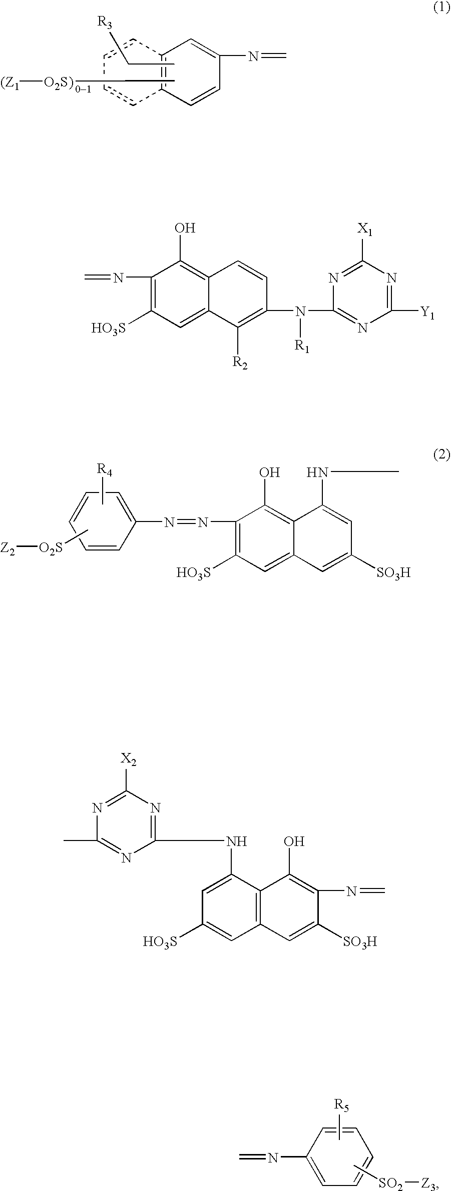 and a dyeing method using the same. The dye mixture of the present invention exhibits superior adsorptivity and fixability when dyeing a fiber material containing nitrogen or hydroxyl group, particularly a cellulose fiber material, and particularly very high light fastness and wet fastness, and thus provides a variety of balanced physical properties which are required in dyeing.

### BACKGROUND OF THE INVENTION

1. Field of the Invention

The present invention relates to a reactive dye composition capable of improving dyeing of a light orange or light red color that is difficult to be achieved by a single dye when dyeing a fiber material containing nitrogen or hydroxyl group, particularly a cellulose fiber, and a method of combination dyeing using the same.

2. Description of the Related Art

As a conventional technique for dyeing a material orange or light red using a reactive dye, it is typical to employ a dyeing method using a mixture of C.I. Reactive Orange 122 compound which is a bifunctional reactive dye and C.I. Reactive Red 195 compound which is a reactive red dye. However, the above-mentioned two compounds generally suffer from disadvantages such as a poor compatibility therebetween, thus lowering reproducibility of desired colors, and dim and blurred colors of dyed products resulting from mixing of dyes. In addition, when it is desired to dye a cellulose fiber material orange or light-red using such dyes, there are disadvantages such as blurred color due to low fixability, probable contamination of other fibers by unfixed dyes, and low wet fastness and low chlorine water fastness, thus resulting in contamination of other fibers after dyeing. Further, unfortunately such a method cannot meet high fastness against light and sweat which is required in dyes.

Meanwhile, dyeing using a reactive dye needs a more economical method in terms of qualities of dyed products and profitability of dyeing processes. Therefore, there is a need for a reactive dye which exhibits sufficient substantivity and at the same time, enables unfixed dyes to be very easily cleaned, when performing a dyeing process. Consequently, there is an urgent need for the development of a novel reactive dye satisfying such requirements while exhibiting high fastness against light or washing.

### SUMMARY OF THE INVENTION

Therefore, the present invention has been made to solve the above problems, and other technical problems that have yet to be resolved.

That is, it is an object of the present invention to provide a reactive dye mixture which has high fixability and high stability of fiber-dye bonding and at the same time, allows dyes not fixed to fibers to be easily washed, and exhibits superior fastness against light or moisture.

As a result of a variety of extensive and intensive studies and experiments to solve the problems as described above, the inventors of the present invention have confirmed that, as compared to conventional monochlorotriazine compounds or heterobifunctional compounds, a novel reactive dye mixture that will be described hereinafter has superior wet wash fastness and light fastness as well as high build-up properties, upon dyeing, and superior adsorptivity and fixability, thus leaving little residual liquor and therefore requiring easier wastewater treatment, and as a result, it is possible to achieve almost all the above-mentioned objects. The present invention has been completed based on these findings.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph showing comparison of light fastness and wet fastness between dye mixtures of Examples 16 and 19 in accordance with the present invention, and C.I. Reactive Orange 122 dye and C.I. Reactive Red 195 dye; and

FIG. 2 is a graph showing comparison of dyeing intensity between dye mixtures of Examples 16 and 19 in accordance with the present invention, and C.I. Reactive Orange 122 dye and C.I. Reactive Red 195 dye.

### DESCRIPTION OF THE PREFERRED EMBODIMENTS

In accordance with an aspect of the present invention, the above and other objects can be accomplished by the provision of a fiber-reactive dye mixture, comprising

(i) one or more reactive dyes represented by Formula 1, and

(ii) one or more reactive dyes represented by Formula 2:

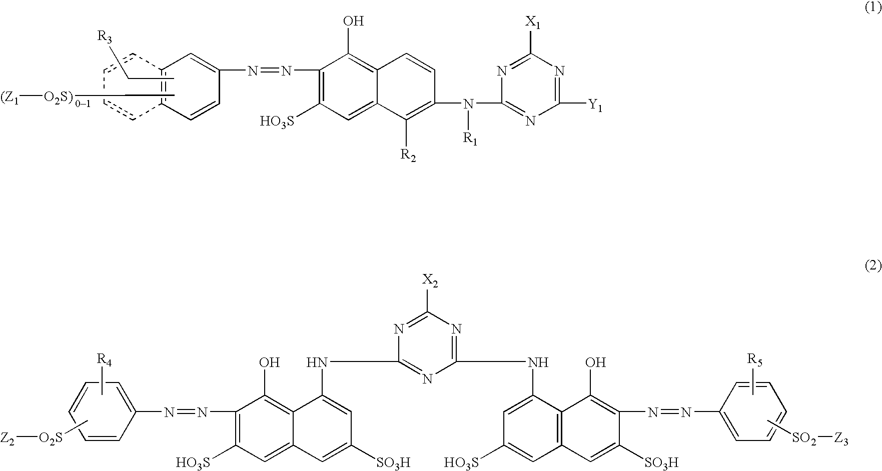

wherein:

R1 is hydrogen, or C1-C4 alkyl which may be substituted or unsubstituted with hydroxyl, sulfo, sulfato or carboxyl group;

R2, R3, R4 and R5 are independently hydrogen, C1-C4 alkyl, C1-C4 alkoxy, C2-C4 alkanoylamino, ureido, sulfamoyl, halogen, sulfo or carboxyl group;

Y1 is a substituent group of Formula 3a, 3b or 3c:

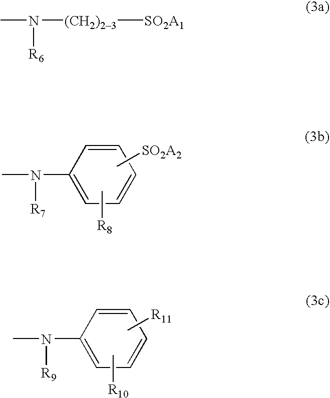

wherein R6, R7 and R9 are independently hydrogen, or C1-C4 alkyl which may be substituted or unsubstituted with hydroxyl, sulfo, sulfato or carboxyl group; R8, R10 and R11 are independently hydrogen, C1-C4 alkyl, C1-C4 alkoxy, C2-C4 alkanoylamino, ureido, sulfamoyl, halogen, sulfo or carboxyl group; and A1 and A2 are independently a vinyl group or a radical of —CH2—CH2-Q, wherein Q is a leaving group that can be removed under alkaline conditions, for example —Cl, —Br, —F, —OSO3H, —SSO3H, —OCO—CH3, —OPO3H2, —OCO—C6H5, —OSO2-C1-C4 alkyl or —OSO2N(C1-C4 alkyl), preferably —OSO3H;

X1 and X2 are independently a substituent group of Formula 3a, 3b or 3c, which is an N-heterocyclic group capable of further containing halogen, hydroxyl, 3-carboxypyridin-1-yl, 3-carbamoylpyridin-1-yl, C1-C4 alkoxy group, C1-C4 alkylthio group, unsubstituted or substituted amino group, or a hetero atom; and

Z1, Z2 and Z3 are independently as defined for A1 and A2.

Amounts of the dye of Formula 1 and the dye of Formula 2 in the fiber-reactive dye mixture may vary depending on a degree of desired coloration. A mixing ratio of the compound of Formula 1 and the compound of Formula 2 is in a range of 5:95 to 95:5 and preferably 30:70 to 70:30.

The fiber-reactive dye mixture in accordance with the present invention exhibits high reproducibility of various colors ranging from light orange to red colors, high fixability and very high build-up ability, as compared to conventional hererobifunctional compounds and vinylsulfone compounds, upon dyeing.

A preferred example of the reactive dye of Formula 1 in accordance with the present invention may include dyes of Formulae 4 and 5:

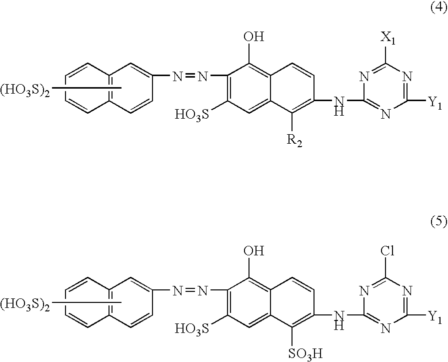

wherein R2, X1 and Y1 are as defined in Formula 1.

A preferred example of the reactive dye of Formula 2 in accordance with the present invention may include dyes of Formulae 6 and 7:

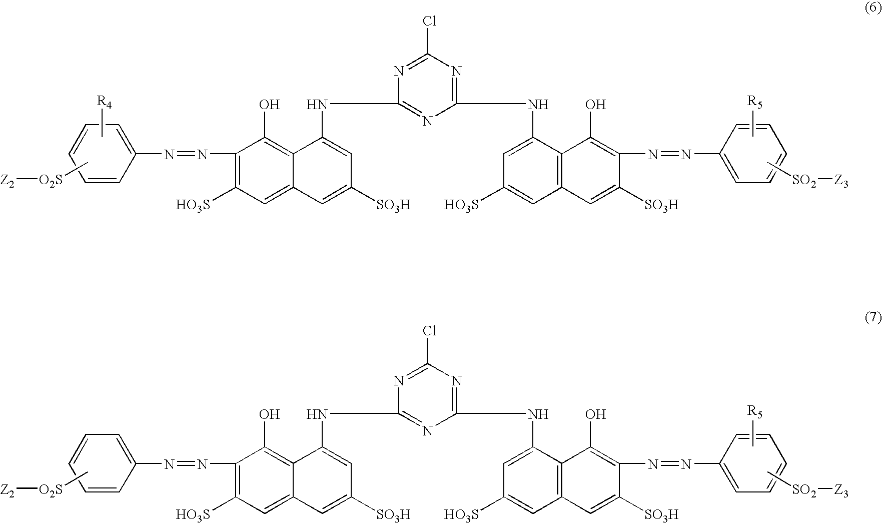

wherein R4, R5, Z2 and Z3 are as defined in Formula 2.

In accordance with another aspect of the present invention, there is provided a method of dyeing a cellulose fiber material, using the above-mentioned fiber-reactive dye mixture.

The fiber-reactive dye mixture in accordance with the present invention is suitable as a dye for dyeing all types of cellulose fiber materials. The cellulose fiber material that can be used in the present invention includes, for example natural cellulose fibers such as cotton, flax and hemp, pulp and recycled cellulose. Particularly preferred is cotton. The fiber-reactive dye mixture in accordance with the present invention is also suitable for dyeing a cellulose blended fabric, for example cotton/polyester, cotton/nylon blended fabric and the like.

An amount of the fiber-reactive dye mixture in the dye solution may vary depending on a degree of desired coloration. For example, the fiber-reactive dye mixture may be used in an amount of 0.01 to 10% by weight, and preferably 0.01 to 6% by weight, based on the fabric to be dyed.

The fiber-reactive dye mixture in accordance with the present invention is particularly suitable for dyeing via an exhaustion method.

The exhaustion method of dyeing is usually carried out in an aqueous medium, at a reaction temperature of 20 to 105° C., preferably 30 to 90° C. and more preferably 40 to 80° C., using the dye and water in a weight ratio of 1:2 to 1:60 and preferably 1:5 to 1:20.

Alternatively, other suitable dyeing methods such as pad dyeing may be used. In pad dyeing, a fabric is typically impregnated and reacted in an aqueous solution, saline or a salt solution. Here, the pick-up rate is in a range of 20 to 150%, and preferably 50 to 100%, based on the weight of the fiber material to be dyed. The aqueous solution may contain a fixing alkali in advance, or if necessary, the fiber material may be treated with the fixing alkali after impregnation. Suitable examples of the alkali metals include sodium carbonate, sodium bicarbonate, sodium hydroxide, disodium phosphate, trisodium phosphate, sodium borate, aqueous ammonia, sodium trichloroacetate, sodium silicate solutions, and a mixture thereof. Among these compounds, an alkali hydroxide and/or alkali carbonate, particularly sodium hydroxide and/or sodium carbonate are preferred.

Fixation of the dye may be carried out, for example by steam-treating the impregnated fiber material at a temperature of 100 to 120° C. for example, particularly via thermal action such as by saturated steam. According to so-called cold pad-batch method, the dye and alkali are introduced into a padder, and they are stored and fixed at room temperature for several hours, for example 3 to 40 hours. After fixation, a dispersant is added to the resulting dyed product, followed by thorough rinsing.

The dyed product obtained according to the present invention exhibits superior build-up and levelness properties. In addition, the dyed product exhibits high fixability of the dye, capability to easily wash and remove the non-fixed dye, and a small difference between adsorptivity and fixability, that is, a low loss of soap. Further, the dyed product obtained exhibits a high degree of coloration, high stability of fiber-dye bonding, superior fastness against washing, brine, cross-dyeing and sweating, and high fastness against wrinkles, ironing and friction, and particularly superior light fastness.

### EXAMPLES

Now, the present invention will be described in more detail with reference to the following Examples. These examples are provided only for illustrating the present invention and should not be construed as limiting the scope and sprit of the present invention.

### Examples 1 through 14

| | |
|---|---|
| | (8) |
| 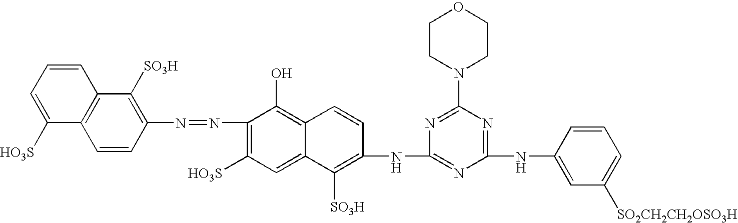 | |
| | (9) |
| 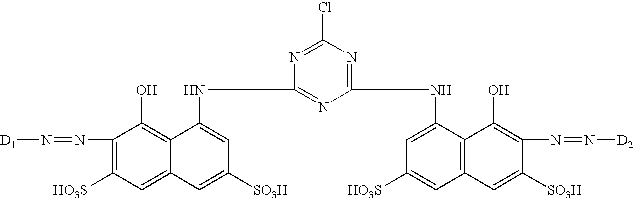 | |

| Ex. No. | D1 | D2 | Compound 8:Compound 9 | Color of dyed product |
|---|---|---|---|---|
| 1 | 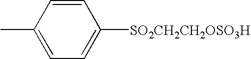 | 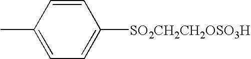 | 10:90 | Red |
| 2 | 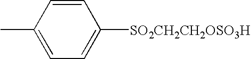 | 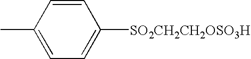 | 30:70 | Deep red |
| 3 | 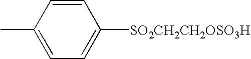 | 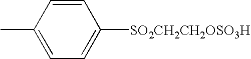 | 50:50 | Scarlet |
| 4 | 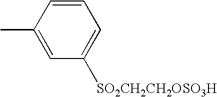 | 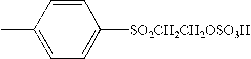 | 10:90 | Red |
| 5 | 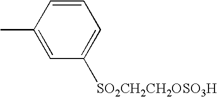 | 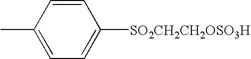 | 30:70 | Deep red |
| 6 | 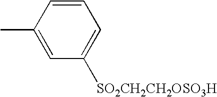 | 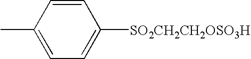 | 50:50 | Scarlet |
| 7 | 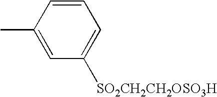 | 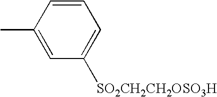 | 30:70 | Deep red |
| 8 | 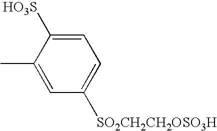 | 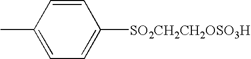 | 30:70 | Deep red |
| 9 | 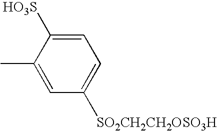 | 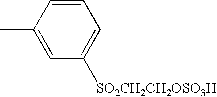 | 30:70 | Deep red |
| 10 | 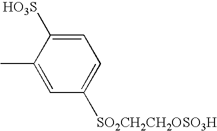 | 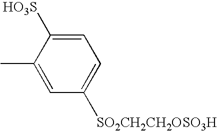 | 30:70 | Deep red |
| 11 | 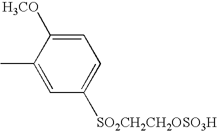 | 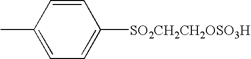 | 30:70 | Deep red |
| 12 | 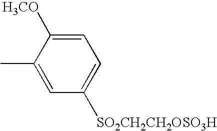 | 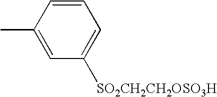 | 30:70 | Deep red |
| 13 | 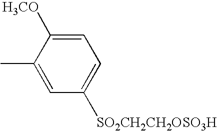 | 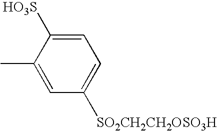 | 30:70 | Deep red |
| 14 | 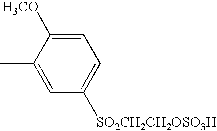 | 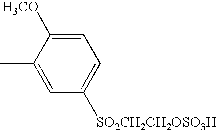 | 30:70 | Deep red |

### Examples 15 through 28

| | |
|---|---|
| | (10) |
| 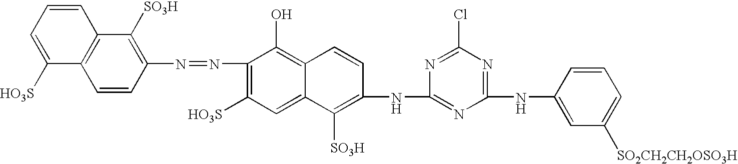 | |

| Ex. No. | D1 | D2 | Compound 10:Compound 9 | Color of dyed product |
|---|---|---|---|---|
| 15 | 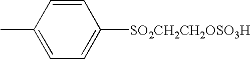 | 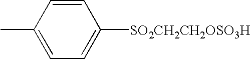 | 10:90 | Red |
| 16 | 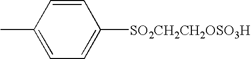 | 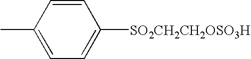 | 30:70 | Deep red |
| 17 | 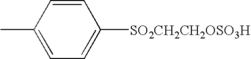 | 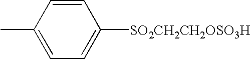 | 50:50 | Scarlet |
| 18 | 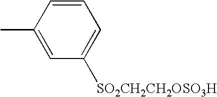 | 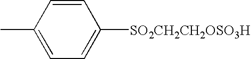 | 10:90 | Red |
| 19 | 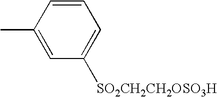 | 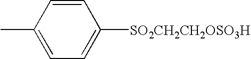 | 30:70 | Deep red |
| 20 | 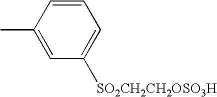 | 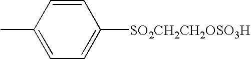 | 50:50 | Scarlet |
| 21 | 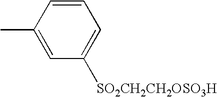 | 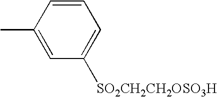 | 30:70 | Deep red |
| 22 | 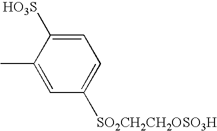 | 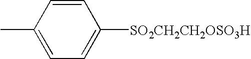 | 30:70 | Deep red |
| 23 | 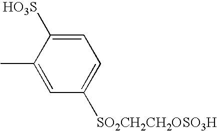 | 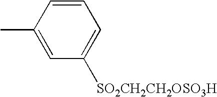 | 30:70 | Deep red |
| 24 | 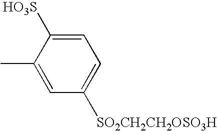 | 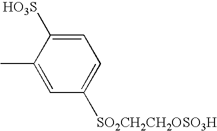 | 30:70 | Deep red |
| 25 | 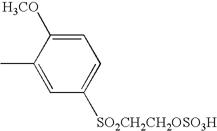 | 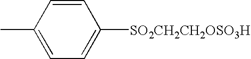 | 30:70 | Deep red |
| 26 | 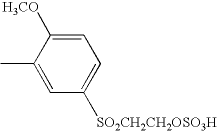 | 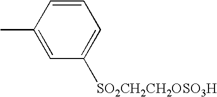 | 30:70 | Deep red |
| 27 | 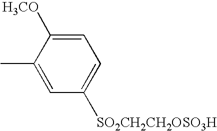 | 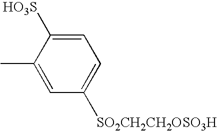 | 30:70 | Deep red |
| 28 | 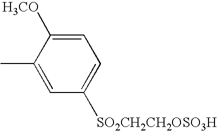 | 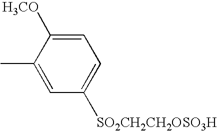 | 30:70 | Deep red |

### Examples 29 through 42

| | |
|---|---|
| | (11) |
| 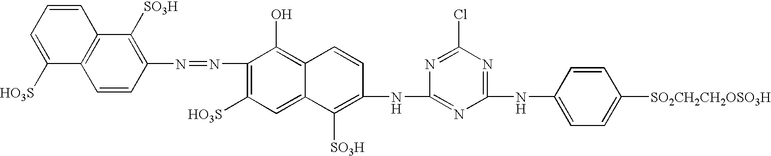 | |

| Ex. No. | D1 | D2 | Compound 10:Compound 9 | Color of dyed product |
|---|---|---|---|---|
| 29 | 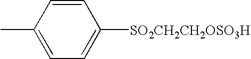 | 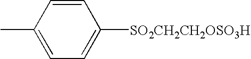 | 10:90 | Red |
| 30 | 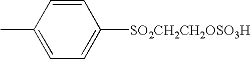 | 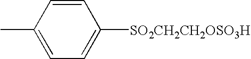 | 30:70 | Deep red |
| 31 | 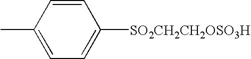 | 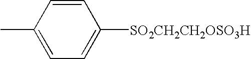 | 50:50 | Scarlet |
| 32 | 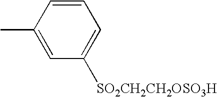 | 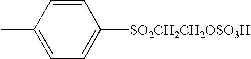 | 10:90 | Red |
| 33 | 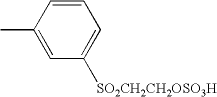 | 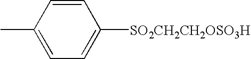 | 30:70 | Deep red |
| 34 | 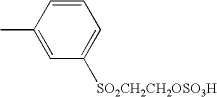 | 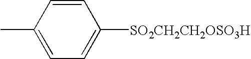 | 50:50 | Scarlet |
| 35 | 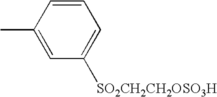 | 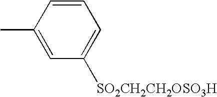 | 30:70 | Deep red |
| 36 | 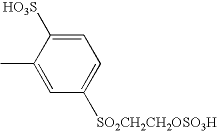 | 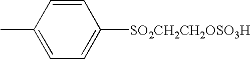 | 30:70 | Deep red |
| 37 | 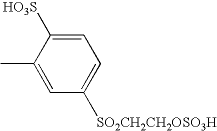 | 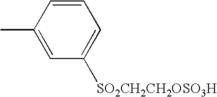 | 30:70 | Deep red |
| 38 | 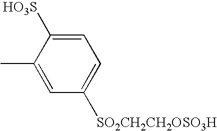 | 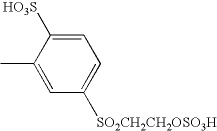 | 30:70 | Deep red |
| 39 | 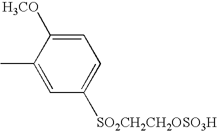 | 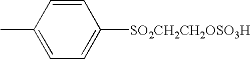 | 30:70 | Deep red |
| 40 | 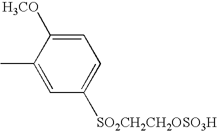 | 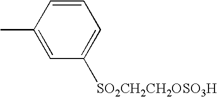 | 30:70 | Deep red |
| 41 | 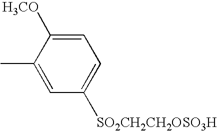 | 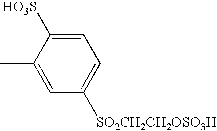 | 30:70 | Deep red |
| 42 | 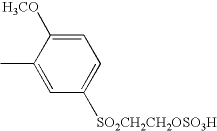 | 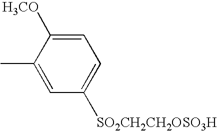 | 30:70 | Deep red |

### Examples 43 through 56

| | |
|---|---|
| | (12) |
| 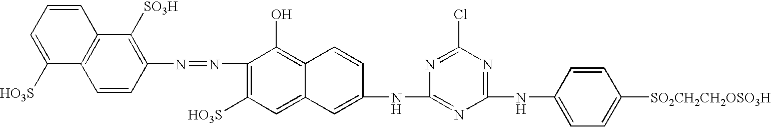 | |

| Ex. No. | D1 | D2 | Compound 10:Compound 9 | Color of dyed product |
|---|---|---|---|---|
| 43 | 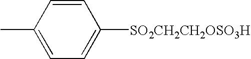 | 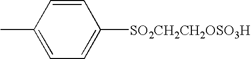 | 10:90 | Red |
| 44 | 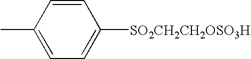 | 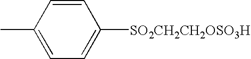 | 30:70 | Deep red |
| 45 | 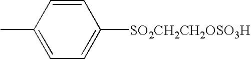 | 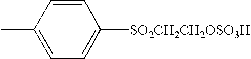 | 50:50 | Scarlet |
| 46 | 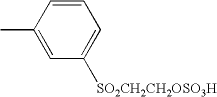 | 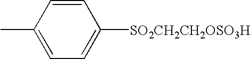 | 10:90 | Red |
| 47 | 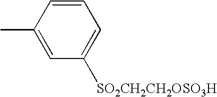 | 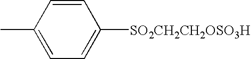 | 30:70 | Deep red |
| 48 | 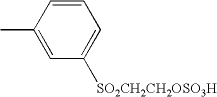 | 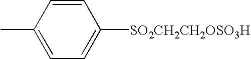 | 50:50 | Scarlet |
| 49 | 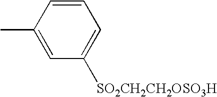 | 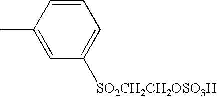 | 30:70 | Deep red |
| 50 | 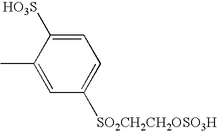 | 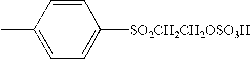 | 30:70 | Deep red |
| 51 | 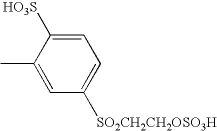 | 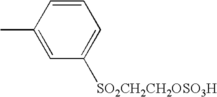 | 30:70 | Deep red |
| 52 | 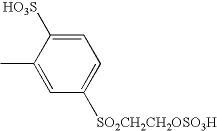 | 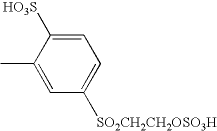 | 30:70 | Deep red |
| 53 | 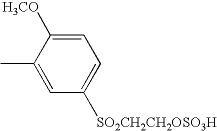 | 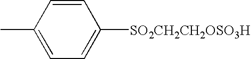 | 30:70 | Deep red |
| 54 | 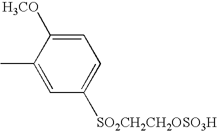 | 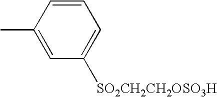 | 30:70 | Deep red |
| 55 | 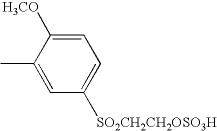 | 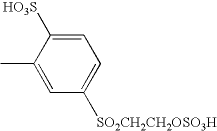 | 30:70 | Deep red |
| 56 | 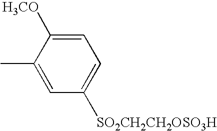 | 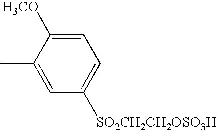 | 30:70 | Deep red |

### Examples 57 through 70

| | |
|---|---|
| | (13) |
| 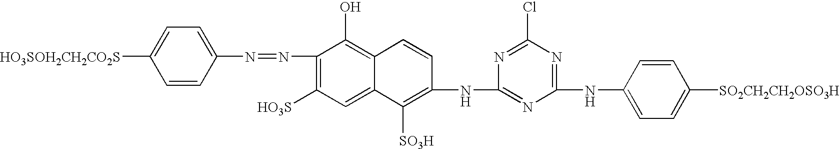 | |

| Ex. No. | D1 | D2 | Compound 10:Compound 9 | Color of dyed product |
|---|---|---|---|---|
| 57 | 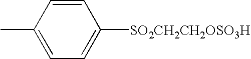 | 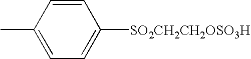 | 10:90 | Red |
| 58 | 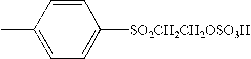 | 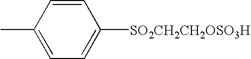 | 30:70 | Deep red |
| 59 | 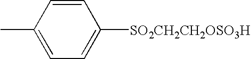 | 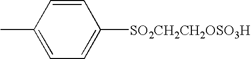 | 50:50 | Scarlet |
| 60 | 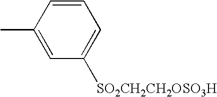 | 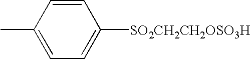 | 10:90 | Red |
| 61 | 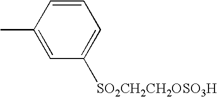 | 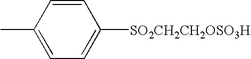 | 30:70 | Deep red |
| 62 | 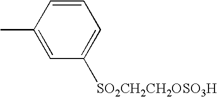 | 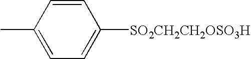 | 50:50 | Scarlet |
| 63 | 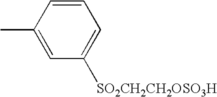 | 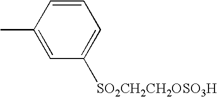 | 30:70 | Deep red |
| 64 | 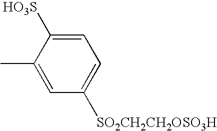 | 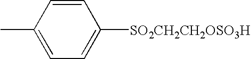 | 30:70 | Deep red |
| 65 | 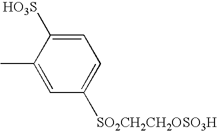 | 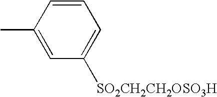 | 30:70 | Deep red |
| 66 | 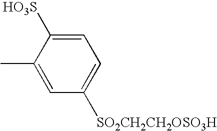 | 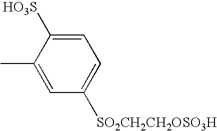 | 30:70 | Deep red |
| 67 | 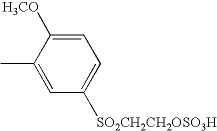 | 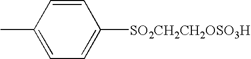 | 30:70 | Deep red |
| 68 | 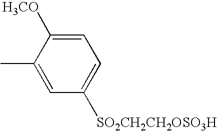 | 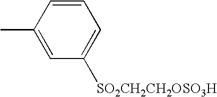 | 30:70 | Deep red |
| 69 | 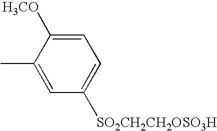 | 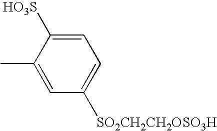 | 30:70 | Deep red |
| 70 | 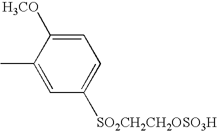 | 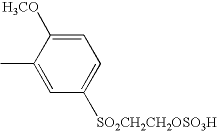 | 30:70 | Deep red |

### Examples 71 through 84

| | |
|---|---|
| | (14) |
| 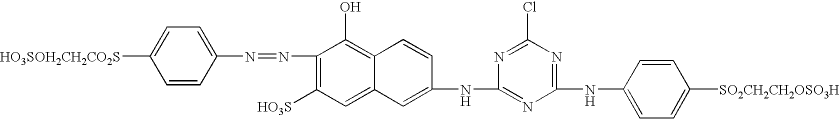 | |

| Ex. No. | D1 | D2 | Compound 10:Compound 9 | Color of dyed product |
|---|---|---|---|---|
| 71 | 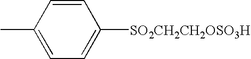 | 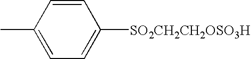 | 10:90 | Red |
| 72 | 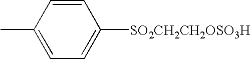 | 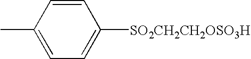 | 30:70 | Deep red |
| 73 | 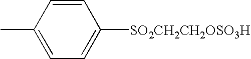 | 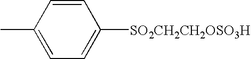 | 50:50 | Scarlet |
| 74 | 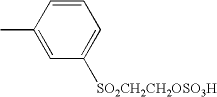 | 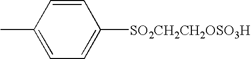 | 10:90 | Red |
| 75 | 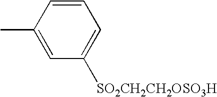 | 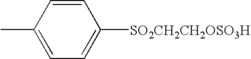 | 30:70 | Deep red |
| 76 | 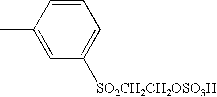 | 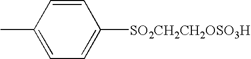 | 50:50 | Scarlet |
| 77 | 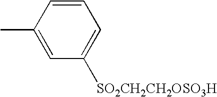 | 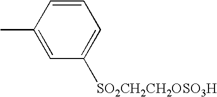 | 30:70 | Deep red |
| 78 | 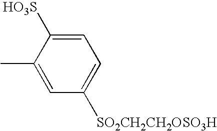 | 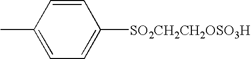 | 30:70 | Deep red |
| 79 | 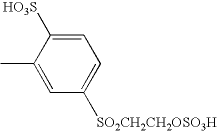 | 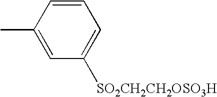 | 30:70 | Deep red |
| 80 | 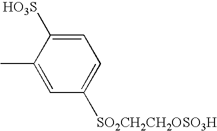 | 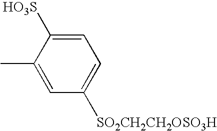 | 30:70 | Deep red |
| 81 | 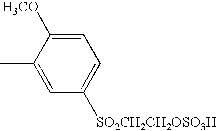 | 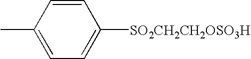 | 30:70 | Deep red |
| 82 | 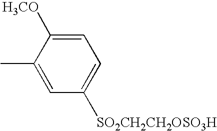 | 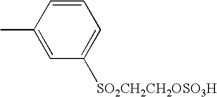 | 30:70 | Deep red |
| 83 | 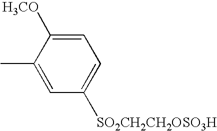 | 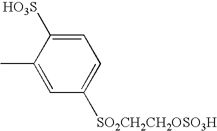 | 30:70 | Deep red |
| 84 | 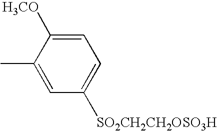 | 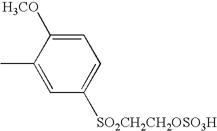 | 30:70 | Deep red |

### Experimental Example

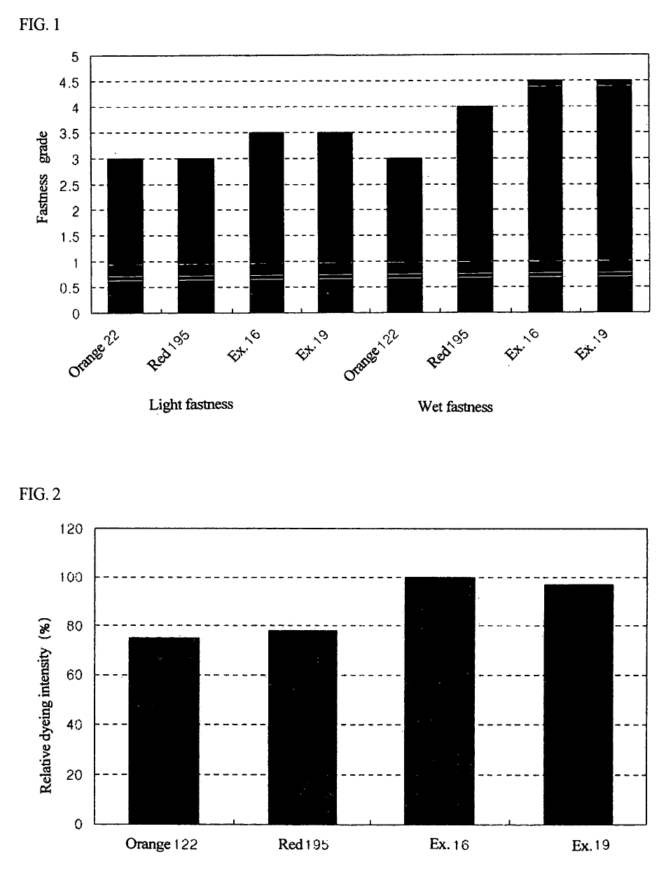

For dye mixtures of Examples 16 and 19, and C.I. Reactive Orange 122 dye, and C.I. Reactive Red 195 dye, dyeing was performed under same conditions via a dip-dyeing method (3% dyeing concentration, a bath ratio of 1:20) and the results thus obtained were compared. For the subject material dyed under the above conditions, a relative dyeing intensity was measured using a calorimeter (made by Gretag Macbeth). In addition, light fastness and wet fastness of the subject material dyed under the above conditions were also measured and compared using the gray scale. The results thus obtained are shown in FIGS. 1 and 2.

As can be seen from FIGS. 1 and 2, it was confirmed that the dye mixtures of Examples 16 and 19 in accordance with the present invention exhibited superior fixability, relative dyeing intensity, light fastness and wet fastness, as compared to C.I. Reactive Orange 122 dye, and C.I. Reactive Red 195 dye.

As apparent from the above description, the fiber-reactive dye mixture in accordance with the present invention exhibits superior adsorptivity and fixability, upon dyeing of a fiber material, particularly a cellulose fiber material by a conventional fixation method, and very high fastness against wet treatment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A fiber-reactive dye mixture, comprising
(i) one or more reactive dyes represented by Formula 1, and
(ii) one or more reactive dyes represented by Formula 2: 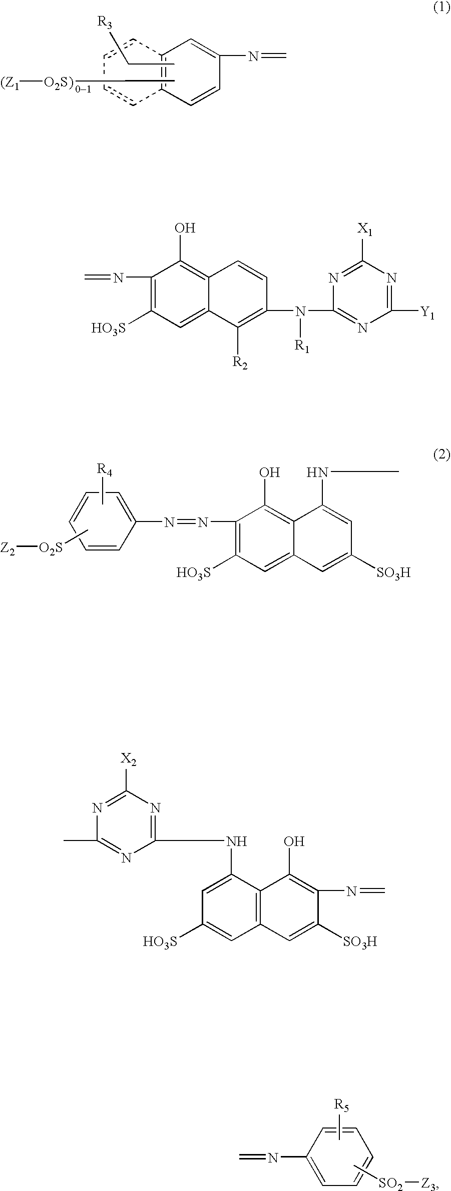
wherein:
R1 is hydrogen, or C1-C4 alkyl which may be substituted or unsubstituted with hydroxyl, sulfo, sulfato or carboxyl group;
R2, R3, R4 and R5 are independently hydrogen, C1-C4 alkyl, C1-C4 alkoxy, C2-C4 alkanoylamino, ureido, sulfamoyl, halogen, sulfo or carboxyl group;
Y1 is a substituent group of Formula 3a, 3b or 3c: 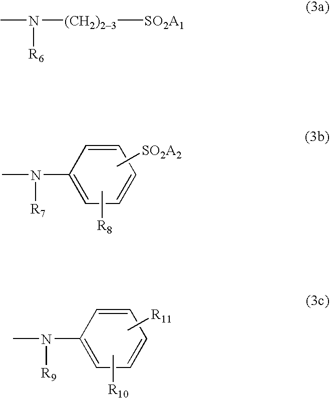
wherein R6, R7 and R9 are independently hydrogen, or C1-C4 alkyl which may be substituted or unsubstituted with hydroxyl, sulfo, sulfato, or carboxyl group; R8, R10 and R11 are independently hydrogen, C1-C4 alkyl, C1-C4 alkoxy, C2-C4 alkanoylamino, ureido, sulfamoyl, halogen, sulfo or carboxyl group; and A1 and A2 are independently a vinyl group or a radical of —CH2—CH2-Q, wherein Q is a leaving group that can be removed under alkaline conditions, for example —Cl, —Br, —F, —OSO3H, —SSO3H, —OCO—CH3, —OPO3H2, —OCO—C6H5, —OSO2-C1-C4 alkyl or —OSO2N(C1-C4 alkyl), preferably —OSO3H;
X1 and X2 are independently a substituent group of Formula 3a, 3b or 3c, which is an N-heterocyclic group capable of further containing halogen, hydroxyl, 3-carboxypyridine-1-yl, 3-carbamoylpyridin-1-yl, C1-C4 alkoxy group, C1-C4 alkylthio group, unsubstituted or substituted amino group, or a hetero atom; and
Z1, Z2 and Z3 are independently as defined for A1 and A2.

2. The fiber-reactive dye mixture according to claim 1, wherein R1 is hydrogen or C1-C4 alkyl.

3. The fiber-reactive dye mixture according to claim 1, wherein X1 and X2 are independently fluorine or chlorine.

4. The fiber-reactive dye mixture according to claim 1, wherein A1 and A2 are independently a vinyl group or a radical of —CH2—CH2-Q, wherein Q is a leaving group that can be removed under alkaline conditions, for example —Cl, —Br, —F, —OSO3H, —SSO3H, —OCO—CH3, —OPO3H2, —OCO—C6H5, —OSO2-C1-C4 alkyl or —OSO2alkyl).

5. The fiber-reactive dye mixture according to claim 1, wherein the reactive dye of Formula 1 is a compound of Formula 4: 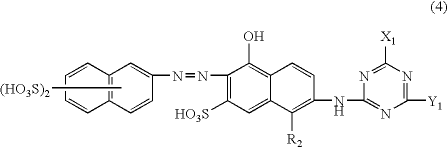
wherein R2, X1 and Y1 are as defined in Formula 1.

6. The fiber-reactive dye mixture according to claim 1, wherein the reactive dye of Formula 1 is a compound of Formula 5: 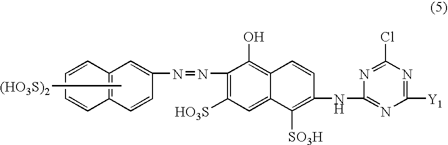
wherein Y1 is as defined in Formula 1.

7. The fiber-reactive dye mixture according to claim 1, wherein the reactive dye of Formula 2 is a compound of Formula 6: 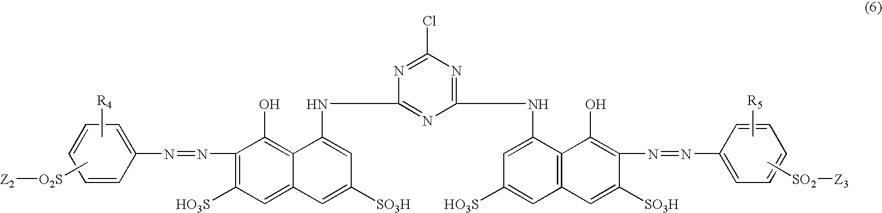
wherein R4, R5, Z2 and Z3 are as defined in Formula 2.

8. The fiber-reactive dye mixture according to claim 1, wherein the reactive dye of Formula 2 is a compound of Formula 7: 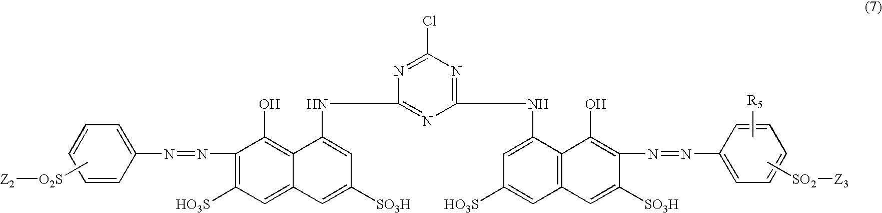
wherein R5, Z2 and Z3 are as defined in Formula 2.

9. A method of dyeing a fiber material containing nitrogen or hydroxyl group using the fiber-reactive dye mixture according to claim 1.
